(19) United States
(12) Patent Application Publication
(10) Pub. No.: US 2026/0178142 A1
(43) Pub. Date: Jun. 25, 2026

(54) SEAMLESS TOUCH DISPLAY MODULE

(71) Applicant: Primax Electronics Ltd., Taipei (TW)

(72) Inventors: Wei-Chiang Huang, Taipei (TW); Wei-Ping Chan, Taipei (TW)

(21) Appl. No.: 19/260,105

(22) Filed: Jul. 3, 2025

(30) Foreign Application Priority Data
Dec. 20, 2024 (TW) 113149781

(51) Int. Cl. G06F 3/041; F21V 8/00

(52) U.S. Cl. CPC G06F 3/0412; G02B 6/0086

(57) ABSTRACT

A seamless touch display module includes a light-transmitting cover, a shielding layer, a printed circuit board assembly (PCBA) and a backlight module. The shielding layer is disposed on a lower surface of the light-transmitting cover to define a light-transmitting region. The PCBA is located beneath the shielding layer and has a touch sensing region, in which a vertical projection of the light-transmitting region is adjacent to or corresponds to a vertical projection of the touch sensing region. The backlight module is located beneath the shielding layer and is disposed on or beneath the PCBA, and includes a light-emitting element and a light guide plate. The vertical projection of the light-transmitting region is located within a vertical projection of the light guide plate. When the backlight module is disposed beneath the PCBA, the PCBA has a through opening corresponding to the light-transmitting region.

### FIELD OF THE INVENTION

The present invention relates to a seamless touch display module.

### BACKGROUND OF THE INVENTION

Some electronic devices currently available on the market are equipped with a touchpad module. A user may slide a finger over the touchpad module to move a cursor on a screen of an electronic device, or press the touchpad module to make the electronic device perform a specific function. In this manner, the user does not need to carry and install an additional mouse.

Generally, a conventional touchpad module is disposed within an opening of a top cover, such that the user can directly see the location of the touchpad and perform related operations. However, such a structure causes a gap between the conventional touchpad module and the top cover.

### SUMMARY OF THE INVENTION

The present invention provides a seamless touch display module, which includes a light-transmitting cover, a shielding layer, a printed circuit board assembly (PCBA) and a backlight module. The shielding layer is disposed on a lower surface of the light-transmitting cover to define a light-transmitting region. The PCBA is located beneath the shielding layer and has a touch sensing region, in which a vertical projection of the light-transmitting region is adjacent to or corresponds to a vertical projection of the touch sensing region. The backlight module is located beneath the shielding layer and is disposed on or beneath the PCBA, and includes a light-emitting element and a light guide plate. The light guide plate is laterally adjacent to the light-emitting element, in which the vertical projection of the light-transmitting region is located within a vertical projection of the light guide plate. When the backlight module is disposed beneath the printed circuit board assembly, the printed circuit board assembly has a through opening corresponding to the light-transmitting region.

In some embodiments of the present invention, a length and a width of the light-transmitting cover are respectively greater than a length and a width of the PCBA.

In some embodiments of the present invention, the light-transmitting region is narrow strip-shaped, and the vertical projection of the light-transmitting region is adjacent to the vertical projection of the touch sensing region.

In some embodiments of the present invention, the backlight module is disposed beneath the PCBA, and the light guide plate is narrow strip-shaped.

In some embodiments of the present invention, the backlight module is disposed on the PCBA, and the light guide plate is rectangular or narrow strip-shaped.

In some embodiments of the present invention, the light-transmitting region is frame-shaped, and the vertical projection of the light-transmitting region is adjacent to and surrounds the vertical projection of the touch sensing region.

In some embodiments of the present invention, the light-transmitting region is rectangular, and the vertical projection of the light-transmitting region corresponds to the vertical projection of the touch sensing region.

In some embodiments of the present invention, the backlight module is disposed on the PCBA, and the light guide plate is rectangular.

In some embodiments of the present invention, the backlight module is disposed on the PCBA, and the light guide plate is fixed between the shielding layer and the PCBA.

In some embodiments of the present invention, the light guide plate has a through hole accommodating the light-emitting element.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a perspective top view of a seamless touch display module according to an embodiment of the present invention.

FIG. 2 is a perspective bottom view of the seamless touch display module of FIG. 1.

FIG. 3 is a cross-sectional view of the seamless touch display module of FIG. 1.

FIG. 4 is a partially enlarged view of the seamless touch display module of FIG. 3.

FIG. 5 is a perspective top view of a seamless touch display module according to another embodiment of the present invention.

FIG. 6 is a perspective bottom view of the seamless touch display module of FIG. 5.

FIG. 7 is a cross-sectional view of the seamless touch display module of FIG. 5.

FIG. 8 is a partially enlarged view of the seamless touch display module of FIG. 7.

FIG. 9 is a perspective top view of a seamless touch display module according to an embodiment of the present invention.

FIG. 10 is a perspective bottom view of the seamless touch display module of FIG. 9.

FIG. 11 is a cross-sectional view of the seamless touch display module of FIG. 9.

FIG. 12 is a partial enlarged view of the seamless touch display module of FIG. 11.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, the conventional touchpad module is disposed within an opening of a top cover. However, such a structure causes a gap between the conventional touchpad module and the top cover. Accordingly, the present invention provides a seamless touch display module, which includes a light-transmitting cover, a shielding layer, a printed circuit board assembly (PCBA) and a backlight module. The light-transmitting cover of the seamless touch display module of the present invention has an operable region corresponding to the touch sensing region of the PCBA and an non-operable region around the operable region, in which the non-operable region of the light-transmitting cover may be equivalent to a top cover (e.g., a C shell of a notebook computer) matched with the conventional touch panel module, so the seamless touch display module does not need to use the top cover matched with the conventional touch panel module. In addition, the seamless touch display module of the present invention provides a display function. When the display function is not activated, the seamless touch display module exhibits a uniform appearance; when the display function is activated, the display effect of the seamless touch display module allows the user to visually identify the location of the operable region. The user may further customize the display effect of the seamless touch display module to achieve a human-machine interaction. Various embodiments of the seamless touch display module of the present invention will be described in detail below.

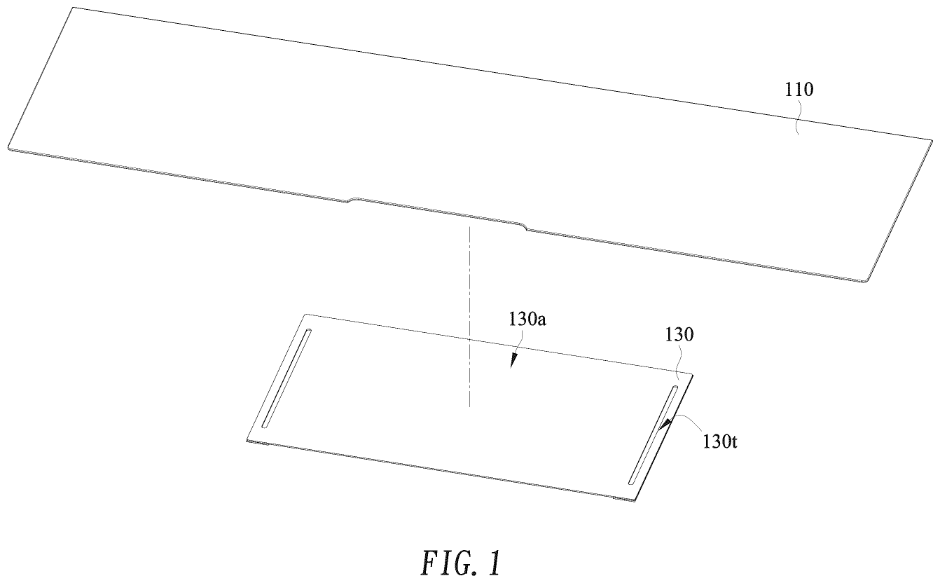

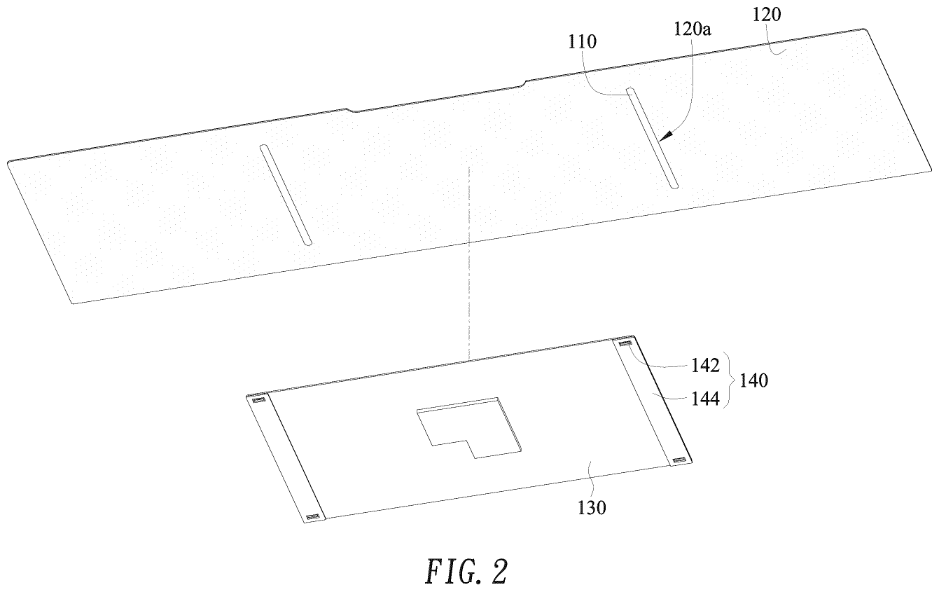

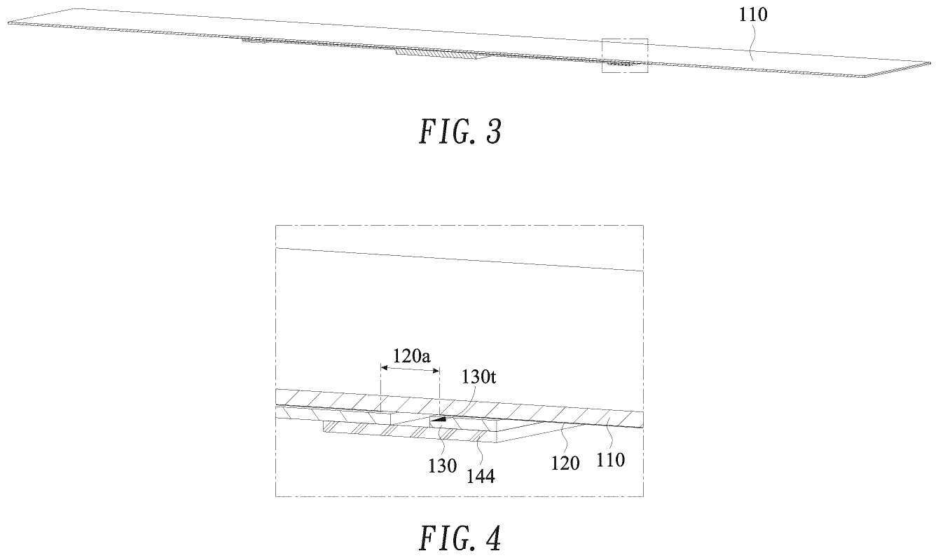

FIG. 1 is a perspective top view of a seamless touch display module according to an embodiment of the present invention. FIG. 2 is a perspective bottom view of the seamless touch display module of FIG. 1. FIG. 3 is a cross-sectional view of the seamless touch display module of FIG. 1. FIG. 4 is a partially enlarged view of the seamless touch display module of FIG. 3. As shown in FIGS. 1 to 4, the seamless touch display module includes a light-transmitting cover 110, a shielding layer 120, a printed circuit board assembly (PCBA) 130, and a backlight module 140.

The light-transmitting cover 110 may be made of glass or other suitable materials. In some embodiments, as shown in FIG. 1, a length and a width of the light-transmitting cover 110 are respectively greater than a length and a width of the PCBA 130. In some embodiments, a ratio of the length of the light-transmitting cover 110 to the length of the PCBA 130 is greater than a ratio of the width of the light-transmitting cover 110 to the width of the PCBA 130.

As shown in FIG. 2, the shielding layer 120 is disposed on a lower surface of the light-transmitting cover 110 to define a light-transmitting region 120a. In some embodiments, the shielding layer 120 is formed on the lower surface of the light-transmitting cover 110 by printing or other suitable processes. The light-transmitting region 120a is configured to allow a user to visually identify an operable region. The light-transmitting region 120a may be designed as any suitable pattern. For example, a pattern of the light-transmitting region 120a may be a narrow strip (e.g., a continuous narrow strip or a discontinuous narrow strip), a frame shape, a rectangular shape, or any other suitable shape. In some embodiments, as shown in FIG. 2, the light-transmitting region 120a is narrow strip-shaped. The term “narrow strip-shaped” refers to a pattern whose length is significantly greater than its width.

In addition, in some embodiments, a length and a width of the shielding layer 120 are respectively greater than the length and the width of the PCBA 130. In some embodiments, a ratio of the length of the shielding layer 120 to the length of the PCBA 130 is greater than a ratio of the width of the shielding layer 120 to the width of the PCBA 130.

As shown in FIG. 1, the PCBA 130 is located beneath the shielding layer 120. The PCBA 130 has a touch sensing region 130a. In some embodiments, a plurality of drive circuits (not shown) and a plurality of sensing circuits (not shown) are disposed on an upper surface of the PCBA 130 to provide a touch function, and a distribution area of the drive circuits and the sensing circuits is the above-mentioned touch sensing region 130a. Generally, an upper surface region of the PCBA 130 substantially corresponds to a distribution area of the touch sensing region 130a. However, in practical applications, the distribution area of the touch sensing region 130a may be adjusted according to other requirements.

As shown in FIGS. 1 and 3 to 4, the PCBA 130 has a through opening 130t corresponding to the light-transmitting region 120 a. A vertical projection of the light-transmitting region 120a is adjacent to a vertical projection of the touch sensing region 130a, so that the user can easily identify the location of the operable region (which corresponds to the touch sensing region 130a). For example, the vertical projection of the light-transmitting region 120a may be partially overlapped (e.g., slightly overlapped) or staggered with the vertical projection of the touch sensing region 130a.

In other embodiments, the light-transmitting region is frame-shaped (not shown), and the vertical projection of the light-transmitting region is adjacent to and surrounds the vertical projection of the touch sensing region, so that the user can easily identify the location of the operable region (which corresponds to the touch sensing region).

As shown in FIGS. 2 to 4, the backlight module 140 is located beneath the shielding layer 120 and is disposed beneath the PCBA 130. The backlight module 140 includes a light-emitting element 142 and a light guide plate 144. In some embodiments, as shown in FIG. 2, the backlight module 140 includes two light guide plates 144 and four light-emitting elements 142, in which two of the light-emitting elements 142 correspond to one of the light guide plates 144, and the other two of the light-emitting elements 142 correspond to the other of the light guide plates 144. However, the present invention is not limited to the aforementioned embodiments. In practical applications, the number and the placement of the light-emitting elements 142 and the light guide plates 144 may be designed based on the location of the light-transmitting region 120a and the desired display effect.

As shown in FIG. 2, the light guide plate 144 is laterally adjacent to the light-emitting element 142. In some embodiments, as shown in FIG. 2, the light guide plate 144 has a through hole (not labeled) that accommodates the light-emitting element 142. However, the present invention is not limited to the aforementioned embodiments. In other embodiments, the light-emitting element (not shown) may be adjacent to an outer edge of the light guide plate. In some embodiments, the light guide plate 144 is narrow strip-shaped.

As shown in FIG. 4, the vertical projection of the light-transmitting region 120a is located within a vertical projection of the light guide plate 144. Please refer to FIGS. 1 to 4. When the seamless touch display module is activated, the light-emitting element 142 emits light, and the light beam enters the light guide plate 144, and then exits from an upper surface of the light guide plate 144, and then passes through the through opening 130t and the light-transmitting region 120a, thereby illuminating a region of the light-transmitting cover 110 corresponding the light-transmitting region 120a. In this manner, the user can visually identify the location of the operable region (which corresponds to the touch sensing region 130a).

In some embodiments, the seamless touch display module further includes a support member (not shown) disposed beneath the light-transmitting cover 110, the PCBA 130, and the backlight module 140, so as to support the light-transmitting cover 110, the PCBA 130, and the backlight module 140. In some embodiments, the support member is a metal member, such as an iron member.

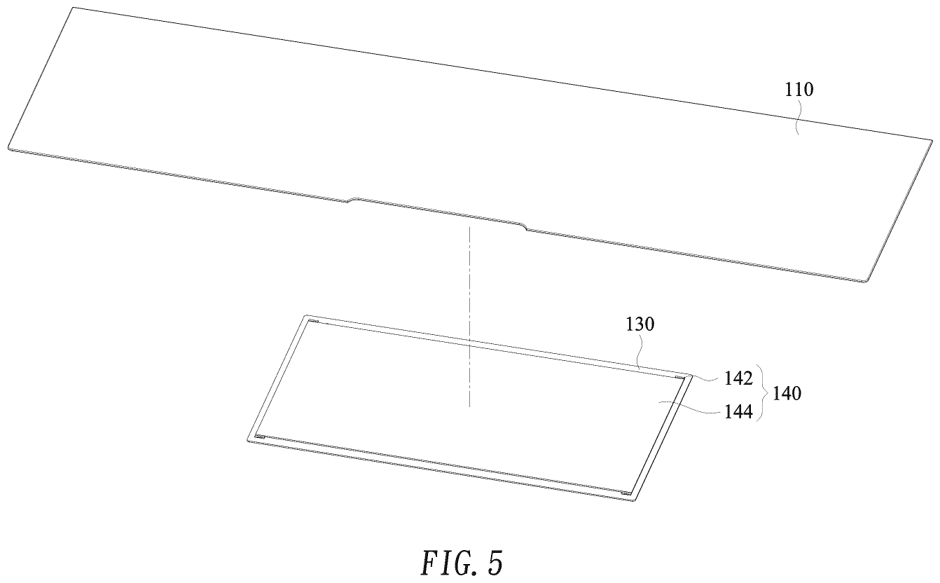

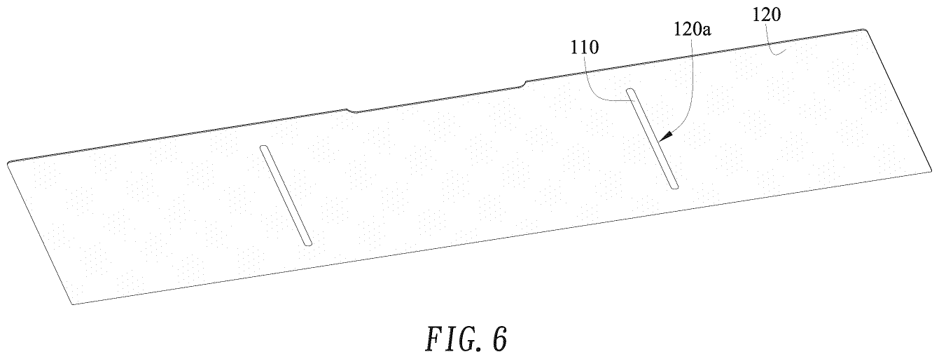

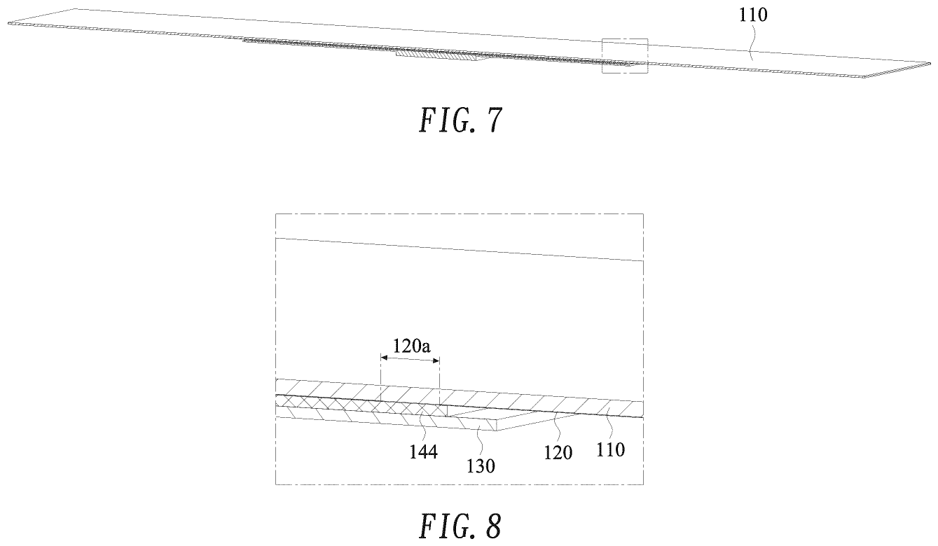

FIG. 5 is a perspective top view of a seamless touch display module according to another embodiment of the present invention. FIG. 6 is a perspective bottom view of the seamless touch display module of FIG. 5. FIG. 7 is a cross-sectional view of the seamless touch display module of FIG. 5. FIG. 8 is a partially enlarged view of the seamless touch display module of FIG. 7. The difference between the embodiments of FIGS. 5 to 8 and the embodiments of FIGS. 1 to 4 is that, as shown in FIGS. 5 to 8, the backlight module 140 is disposed on the PCBA 130; the PCBA 130 does not have a through opening corresponding to the light-transmitting region 120a; the light-emitting element 142 is adjacent to an outer edge of the light guide plate 144; the light guide plate 144 is fixed between the shielding layer 120 and the PCBA 130; and the light guide plate 144 is rectangular. However, the present invention is not limited to the aforementioned embodiments. In other embodiments, the light guide plate may be narrow strip-shaped as shown in FIG. 2.

Please refer to FIGS. 5 to 8. When the seamless touch display module is activated, the light-emitting element 142 emits light, and the light beam enters the light guide plate 144, and then exits from the upper surface of the light guide plate 144, and then passes through the light-transmitting region 120a, thereby illuminating a region of the light-transmitting cover 110 corresponding the light-transmitting region 120a, so that the user can visually identify the location of the operable region (which corresponds to the touch sensing region).

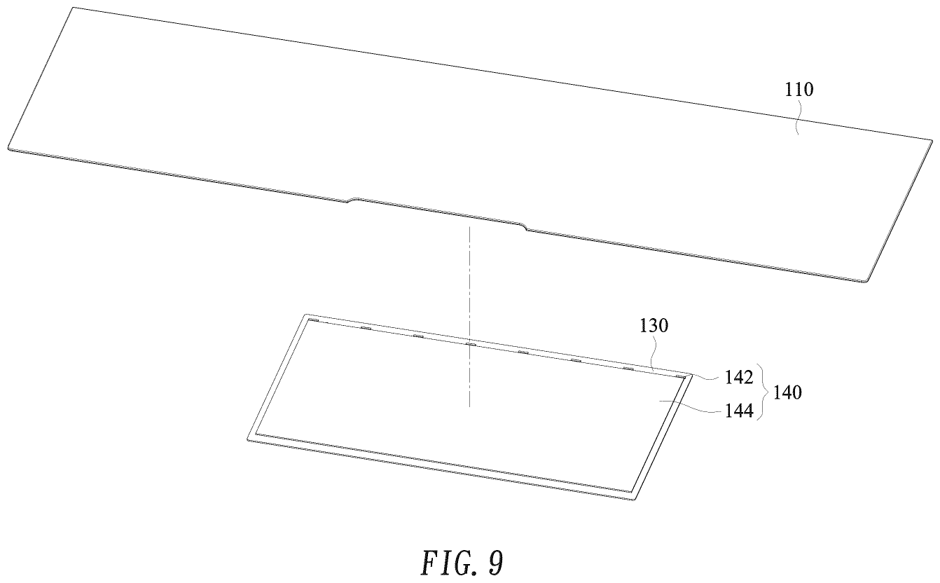

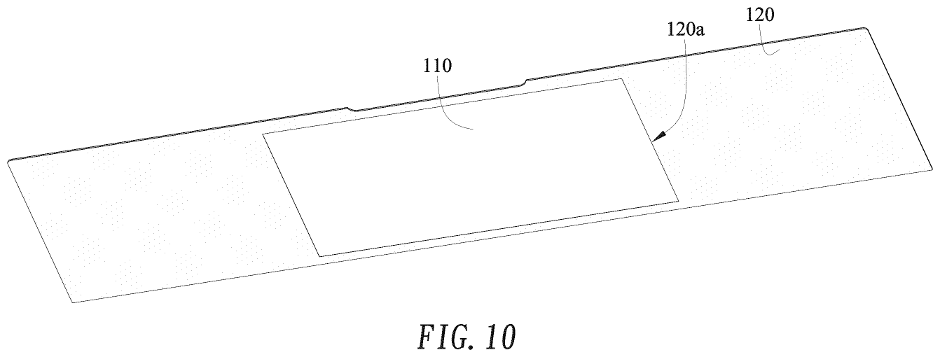

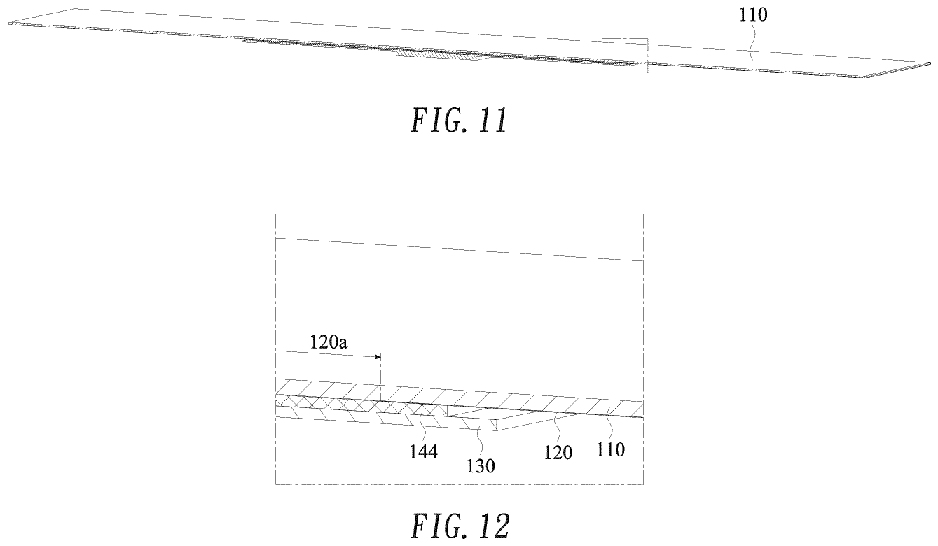

FIG. 9 is a perspective top view of a seamless touch display module according to an embodiment of the present invention. FIG. 10 is a perspective bottom view of the seamless touch display module of FIG. 9. FIG. 11 is a cross-sectional view of the seamless touch display module of FIG. 9. FIG. 12 is a partial enlarged view of the seamless touch display module of FIG. 11. The difference between the embodiments of FIGS. 9 to 12 and the embodiments of FIGS. 5 to 8 is that, as shown in FIGS. 9 to 12, the light-transmitting region 120a is rectangular, and the vertical projection of the light-transmitting region 120a corresponds to (or is substantially aligned with) the vertical projection of the touch sensing region; a plurality of light-emitting elements 142 are disposed at one side of the light guide plate 144.

Referring to FIGS. 9 to 12, when the seamless touch display module is activated, the light-emitting element 142 emits light, and the light beam enters the light guide plate 144, and then exits from the upper surface of the light guide plate 144, and then passes through the light-transmitting region 120a, thereby illuminating a region of the light-transmitting cover 110 corresponding the light-transmitting region 120a, so that the user can visually identify the location of the operable region (which corresponds to the touch sensing region).

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. A seamless touch display module, comprising:
a light-transmitting cover;
a shielding layer, disposed on a lower surface of the light-transmitting cover to define a light-transmitting region;
a printed circuit board assembly (PCBA), located beneath the shielding layer and having a touch sensing region, wherein a vertical projection of the light-transmitting region is adjacent to or corresponds to a vertical projection of the touch sensing region; and
a backlight module, located beneath the shielding layer and disposed on or beneath the PCBA, and comprising:
a light-emitting element; and
a light guide plate, laterally adjacent to the light-emitting element, wherein the vertical projection of the light-transmitting region is located within a vertical projection of the light guide plate,
wherein when the backlight module is disposed beneath the PCBA, the PCBA has a through opening corresponding to the light-transmitting region.

2. The seamless touch display module of claim 1, wherein a length and a width of the light-transmitting cover are respectively greater than a length and a width of the PCBA.

3. The seamless touch display module of claim 1, wherein the light-transmitting region is narrow strip-shaped, and the vertical projection of the light-transmitting region is adjacent to the vertical projection of the touch sensing region.

4. The seamless touch display module of claim 3, wherein the backlight module is disposed beneath the PCBA, and the light guide plate is narrow strip-shaped.

5. The seamless touch display module of claim 3, wherein the backlight module is disposed on the PCBA, and the light guide plate is rectangular or narrow strip-shaped.

6. The seamless touch display module of claim 1, wherein the light-transmitting region is frame-shaped, and the vertical projection of the light-transmitting region is adjacent to and surrounds the vertical projection of the touch sensing region.

7. The seamless touch display module of claim 1, wherein the light-transmitting region is rectangular, and the vertical projection of the light-transmitting region corresponds to the vertical projection of the touch sensing region.

8. The seamless touch display module of claim 7, wherein the backlight module is disposed on the PCBA, and the light guide plate is rectangular.

9. The seamless touch display module of claim 1, wherein the backlight module is disposed on the PCBA, and the light guide plate is fixed between the shielding layer and the PCBA.

10. The seamless touch display module of claim 1, wherein the light guide plate has a through hole accommodating the light-emitting element.
